(19) United States
(12) Patent Application Publication
(10) Pub. No.: US 2026/0205985 A1
(43) Pub. Date: Jul. 16, 2026

(54) METHODS AND APPARATUSES FOR HYBRID POSITIONING

(71) Applicant: Lenovo (Beijing) Limited, Beijing (CN)

(72) Inventors: Luning Liu, Beijing (CN); Jing Han, Beijing (CN); Jie Hu, Beijing (CN); Haiming Wang, Beijing (CN); Lihua Yang, Beijing (CN)

(73) Assignee: Lenovo (Beijing) Limited, Beijing (CN)

(21) Appl. No.: 19/133,864

(22) PCT Filed: Dec. 2, 2022
(86) PCT No.: PCT/CN2022/136198

§ 371 Date: May 29, 2025

(51) Int. Cl. H04W 64/00; H04L 5/00; H04W 24/10; H04W 92/18

(52) U.S. Cl. CPC H04W 64/00; H04L 5/0051; H04W 24/10; H04W 92/18

(57) ABSTRACT

Embodiments of the present disclosure relate to methods and apparatuses for hybrid positioning. According to an embodiment of the present disclosure, a first user equipment (UE) may include: a processor; and a transceiver coupled to the processor, wherein the processor is configured to: receive a first request, via the transceiver, from a location management function (LMF) of a wireless network, the first request indicating to the first UE for obtaining measurement information associated with a position of the first UE; responsive to the first request being received from the LMF, and in the case that a Uu positioning configuration and a sidelink (SL) positioning configuration of the first UE are not operationally aligned, obtain an updated positioning configuration for obtaining the measurement information associated with the position of the first UE; obtain the measurement information associated with the position of the first UE using the updated positioning configuration; and transmit the obtained measurement information, via the transceiver, to the LMF for determining the position of the first UE.

### TECHNICAL FIELD

Embodiments of the present application generally relate to wireless communication technologies, and especially to methods and apparatuses for hybrid positioning.

### BACKGROUND

In 3rd generation partnership project (3GPP) Release 18, it was agreed to study architecture and procedures with respect to hybrid positioning, e.g., a combination of Uu based positioning and PC5 based positioning. The hybrid positioning may also be referred to as a combined Uu and PC5 based positioning, a hybrid Uu+PC5 positioning, a combined Uu and sidelink (SL) based positioning, a hybrid Uu+SL positioning, a hybrid Uu and PC5 positioning, a hybrid Uu and SL positioning, or the like. The hybrid positioning shows advantages when a standalone Uu or SL positioning is not possible or cannot satisfy requirements of a positioning or location service. Currently, details regarding the hybrid positioning have not been discussed yet.

### SUMMARY OF THE APPLICATION

Embodiments of the present application at least provide technical solutions for hybrid positioning.

According to some embodiments of the present application, a first user equipment (UE) may include: a processor; and a transceiver coupled to the processor, wherein the processor is configured to: receive a first request, via the transceiver, from a location management function (LMF) of a wireless network, the first request indicating to the first UE for obtaining measurement information associated with a position of the first UE; responsive to the first request being received from the LMF, and in the case that a Uu positioning configuration and an SL positioning configuration of the first UE are not operationally aligned, obtain an updated positioning configuration for obtaining the measurement information associated with the position of the first UE; obtain the measurement information associated with the position of the first UE using the updated positioning configuration; and transmit the obtained measurement information, via the transceiver, to the LMF for determining the position of the first UE.

In some embodiments of the present application, the processor is further configured to transmit, via the transceiver, Uu measurement information associated with the position of the first UE to the LMF, and the first request is received based at least in part on the Uu measurement information.

In some embodiments of the present application, the processor is further configured to: receive, via the transceiver, condition(s) from the LMF, and transmit, via the transceiver, a first assistance data in response to that the condition(s) is satisfied, wherein the first request is received based at least in part on the first assistance data.

In some embodiments of the present application, the condition(s) includes: a link quality of at least one Uu connection is lower than a first pre-defined threshold during a time window, while a link quality of at least one other Uu connection is higher than a second pre-defined threshold during the time window; and at least one SL connection can be established and a link quality of the at least one SL connection is higher than a third pre-defined threshold during the time window.

In some embodiments of the present application, the first assistance data indicates at least one of: the condition(s) is satisfied; or at least one second UE for performing SL positioning for the first UE and a link quality of an SL connection between each of the at least one second UE and the first UE.

In some embodiments of the present application, the first request includes at least one of: information of at least one second UE for performing SL positioning for the first UE; a second request indicating the first UE to discover second UE(s) for performing SL positioning for the first UE; or an updated Uu positioning configuration.

In some embodiments of the present application, the processor is further configured to: in the case that the first request includes the information of at least one second UE, discover the at least one second UE and establish an SL connection with the at least one second UE; or in the case that the first request includes the second request indicating the first UE to discover second UE(s), discover a set of candidate second UEs and select one or more second UEs from the set of candidate second UEs for establishing SL connection(s) with the one or more second UEs.

In some embodiments of the present application, the processor is further configured to transmit, via the transceiver, a response indicating at least one of the following to the LMF: a confirmation of the first request; or one or more second UEs selected by the first UE for performing SL positioning for the first UE.

In some embodiments of the present application, the updated positioning configuration is either an SL positioning configuration or a Uu positioning configuration.

In some embodiments of the present application, the processor is further configured to: receive, via the transceiver, information of a Uu positioning reference signal (PRS) processing window (PPW) from a serving base station (BS) of the first UE; and determine an SL PPW aligned with the Uu PPW based at least in part on the information of the Uu PPW.

In some embodiments of the present application, the processor is configured to receive, via the transceiver, information of an SL PPW from a serving BS of the first UE or from the LMF, wherein the SL PPW aligns with a Uu PPW configured for the first UE.

In some embodiments of the present application, the processor is further configured to transmit, via the transceiver, SL measurement information associated with the position of the first UE or a second assistance data to the LMF, and the first request is received based at least in part on the SL measurement information or the second assistance data, wherein the second assistance data indicates at least one of: a position estimation of the first UE computed based on SL measurement information associated with the position of the first UE failing to satisfy a quality of service (QOS) requirement of a positioning service; or a failure of SL measurement.

In some embodiments of the present application, the condition(s) includes: a link quality of at least one SL connection associated with at least one second UE is lower than a fourth pre-defined threshold during a time window and the first UE cannot find one or more second UEs to replace the at least one second UE for performing SL positioning for the first UE during the time window, while a link quality of one or more other SL connections is higher than a fifth pre-defined threshold during the time window, wherein a number of the one or more other SL connections is no more than a requested number; and at least one Uu connection can be established and a link quality of the at least one Uu connection is higher than a sixth pre-defined threshold during the time window.

In some embodiments of the present application, the first request includes at least one of: information of BS(s) for performing Uu positioning for the first UE; updated information of second UE(s) for performing SL positioning for the first UE; or a third request indicating the first UE to reselect second UE(s) for performing SL positioning for the first UE.

In some embodiments of the present application, the processor is further configured to reselect one or more second UEs for performing SL positioning for the first UE in the case that the first request includes the third request indicating the first UE to reselect second UE(s).

In some embodiments of the present application, the processor is further configured to transmit, via the transceiver, a response indicating at least one of the following to the LMF: a confirmation of the first request; or one or more second UEs reselected by the first UE for performing SL positioning for the first UE.

In some embodiments of the present application, the processor is configured to receive, via the transceiver, information of a Uu PPW and associated identity(ies) (ID(s)) from a serving BS of the first UE, wherein the Uu PPW aligns with an SL PPW.

In some embodiments of the present application, the processor is further configured to transmit, via the transceiver, information of the SL PPW to the serving BS of the first UE.

In some embodiments of the present application, the processor is configured to receive, via the transceiver, information of the SL PPW together with the information of the Uu PPW from the serving BS of the first UE.

In some embodiments of the present application, the measurement information is comprised in a measurement report.

According to some embodiments of the present application, an LMF of a wireless network may include: a processor; and a transceiver coupled to the processor, wherein the processor is configured to: transmit a first request, via the transceiver, to a first UE, the first request indicating to the first UE for obtaining measurement information associated with a position of the first UE; responsive to the first request being transmitted from the LMF, and in the case that a Uu positioning configuration and an SL positioning configuration of the first UE are not operationally aligned, transmit an updated positioning configuration, via the transceiver, to the first UE for the first UE to obtain the measurement information associated with the position of the first UE; and receive, via the transceiver, the measurement information from the first UE for determining the position of the first UE.

In some embodiments of the present application, the processor is further configured to receive, via the transceiver, at least one of: first Uu measurement information associated with the position of the first UE from the first UE; or second Uu measurement information associated with the position of the first UE from at least one BS for performing Uu positioning for the first UE; and the processor is further configured to determine, before the first request is transmitted, to initiate a hybrid positioning procedure in response to at least one of: a position estimation of the first UE computed based on the at least one of the first Uu measurement information or the second Uu measurement information failing to satisfy a QoS requirement of a positioning service; or the at least one of the first Uu measurement information or the second Uu measurement information indicating a failure of Uu measurement.

In some embodiments of the present application, the processor is further configured to transmit, via the transceiver, first condition(s) to the first UE.

In some embodiments of the present application, the first condition(s) includes: a link quality of at least one Uu connection is lower than a first pre-defined threshold during a time window, while a link quality of at least one other Uu connection is higher than a second pre-defined threshold during the time window; and at least one SL connection can be established and a link quality of the at least one SL connection is higher than a third pre-defined threshold during the time window.

In some embodiments of the present application, the processor is further configured to receive, via the transceiver, at least one of: a first assistance data from the first UE, wherein the first assistance data indicates at least one of: the first condition(s) is satisfied; or at least one second UE for performing SL positioning for the first UE and a link quality of an SL connection between each of the at least one second UE and the first UE; or a second assistance data from at least one BS for performing Uu positioning for the first UE, wherein the second assistance data indicates that second condition(s) at the at least one BS is satisfied; and wherein the processor is further configured to determine, before the first request is transmitted, to initiate a hybrid positioning procedure based on the at least one of the first assistance data or the second assistance data.

In some embodiments of the present application, the first request includes at least one of: information of at least one second UE for performing SL positioning for the first UE; a second request indicating the first UE to discover second UE(s) for performing SL positioning for the first UE; or an updated Uu positioning configuration.

In some embodiments of the present application, the processor is further configured to transmit, via the transceiver, an updated Uu positioning configuration to at least one BS which performs a Uu positioning procedure with the first UE.

In some embodiments of the present application, the processor is further configured to receive, via the transceiver, a response indicating at least one of the following from the first UE: a confirmation of the first request; or one or more second UEs selected by the first UE for performing SL positioning for the first UE.

In some embodiments of the present application, the updated positioning configuration is either an SL positioning configuration or a Uu positioning configuration.

In some embodiments of the present application, the processor is further configured to transmit, via the transceiver, information of second UE(s) for performing SL positioning for the first UE to a serving BS of the first UE.

In some embodiments of the present application, the processor is further configured to: receive, via the transceiver, information of a Uu PPW from a serving BS of the first UE; and transmit, via the transceiver, the information of the Uu PPW and information of second UE(s) for performing SL positioning for the first UE to at least one serving BS of at least one second UE of the second UE(s).

In some embodiments of the present application, the processor is further configured to: receive, via the transceiver, information of a Uu PPW from a serving BS of the first UE; and determine an SL PPW based at least in part on the information of the Uu PPW, wherein the SL PPW aligns with the Uu PPW.

In some embodiments of the present application, the processor is further configured to: receive, via the transceiver, SL measurement information associated with the position of the first UE or a third assistance data from at least one of the first UE or second UE(s) for performing SL positioning for the first UE; and determine, before the first request is transmitted, to initiate a hybrid positioning procedure in response to at least one of: a position estimation of the first UE computed based on the received SL measurement information failing to satisfy a QoS requirement of a positioning service, the received SL measurement information indicating a failure of SL measurement, or the third assistance data indicating at least one of: a position estimation of the first UE computed based on SL measurement information associated with the position of the first UE failing to satisfy a QoS requirement of a positioning service; or a failure of SL measurement.

In some embodiments of the present application, the first condition(s) includes: a link quality of at least one SL connection associated with at least one second UE is lower than a fourth pre-defined threshold during a time window and the first UE cannot find one or more second UEs to replace the at least one second UE for performing SL positioning for the first UE during the time window, while a link quality of one or more other SL connections is higher than a fifth pre-defined threshold during the time window, wherein a number of the one or more other SL connections is no more than a requested number; and at least one Uu connection can be established and a link quality of the at least one Uu connection is higher than a sixth pre-defined threshold during the time window.

In some embodiments of the present application, the first request includes at least one of: information of BS(s) for performing Uu positioning for the first UE; updated information of second UE(s) for performing SL positioning for the first UE; or a third request indicating the first UE to reselect second UE(s) for performing SL positioning for the first UE.

In some embodiments of the present application, the processor is further configured to receive, via the transceiver, a response indicating at least one of the following from the first UE: a confirmation of the first request; or one or more second UEs reselected by the first UE for performing SL positioning for the first UE.

In some embodiments of the present application, the processor is further configured to transmit, via the transceiver, at least one of the following to a serving BS of the first UE: information of an SL PPW; or updated information of second UE(s) for performing SL positioning for the first UE.

In some embodiments of the present application, the measurement information is comprised in a measurement report.

According to some embodiments of the present application, a BS may include: a processor; and a transceiver coupled to the processor, wherein the processor is configured to: obtain information related to an SL positioning for a first UE for which a transition from a standalone Uu or SL positioning to a hybrid Uu and SL positioning is initiated; determine at least one of a Uu PPW or an SL PPW based at least in part on the information related to the SL positioning for the first UE; and transmit, via the transceiver, information of the determined at least one of the Uu PPW or the SL PPW to at least one of the first UE or second UE(s) for performing SL positioning for the first UE.

In some embodiments of the present application, the processor is further configured to: transmit, via the transceiver, Uu measurement information associated with the position of the first UE to an LMF of a wireless network; or transmit, via the transceiver, an assistance data to the LMF in response to that condition(s) at the BS is satisfied.

In some embodiments of the present application, the information related to SL positioning for the first UE includes information of second UE(s) for performing SL positioning for the first UE from an LMF of a wireless network, and the processor is configured to: determine an SL PPW which aligns with a Uu PPW configured for the first UE based at least in part on the information of the second UE(s), and transmit, via the transceiver, information of the determined SL PPW to at least one of the first UE or the second UE(s).

In some embodiments of the present application, the information related to SL positioning for the first UE includes information of an SL PPW from the first UE, from a serving BS of a second UE performing SL positioning for the first UE, from an LMF of a wireless network, or determined by the BS, and the processor is configured to: determine a Uu PPW which aligns with the SL PPW indicated by the information related to SL positioning for the first UE, and transmit, via the transceiver, information of the determined Uu PPW to the first UE.

In some embodiments of the present application, the information related to SL positioning for the first UE includes updated information of second UE(s) for performing SL positioning for the first UE from an LMF of a wireless network; and the processor is configured to: determine a Uu PPW and an SL PPW based at least in part on the updated information of second UE(s), wherein the Uu PPW aligns with the SL PPW; and transmit, via the transceiver, information of the determined Uu PPW to the first UE and information of the determined SL PPW to at least one of the first UE or the second UE(s).

According to some embodiments of the present application, a method performed by a first UE may include: receiving a first request from an LMF of a wireless network, the first request indicating to the first UE for obtaining measurement information associated with a position of the first UE; responsive to the first request being received from the LMF, and in the case that a Uu positioning configuration and an SL positioning configuration of the first UE are not operationally aligned, obtaining an updated positioning configuration for obtaining the measurement information associated with the position of the first UE; obtaining the measurement information associated with the position of the first UE using the updated positioning configuration; and transmitting the obtained measurement information to the LMF for determining the position of the first UE.

According to some embodiments of the present application, a method performed by an LMF of a wireless network may include: transmitting a first request to a first UE, the first request indicating to the first UE for obtaining measurement information associated with a position of the first UE; responsive to the first request being transmitted from the LMF, and in the case that a Uu positioning configuration and an SL positioning configuration of the first UE are not operationally aligned, transmitting an updated positioning configuration to the first UE for the first UE to obtain the measurement information associated with the position of the first UE; and receiving the measurement information from the first UE for determining the position of the first UE.

According to some embodiments of the present application, a method performed by a BS may include: obtaining information related to an SL positioning for a first UE for which a transition from a standalone Uu or SL positioning to a hybrid Uu and SL positioning is initiated; determining at least one of a Uu PPW or an SL PPW based at least in part on the information related to the SL positioning for the first UE; and transmitting information of the determined at least one of the Uu PPW or the SL PPW to at least one of the first UE or second UE(s) for performing SL positioning for the first UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary procedure for configuring a PPW;

FIG. 3 illustrates an exemplary scenario for a hybrid Uu and SL positioning according to some embodiments of the present application;

FIG. 4 illustrates an exemplary method for hybrid positioning according to some embodiments of the present application;

FIG. 5 illustrates another exemplary method for hybrid positioning according to some embodiments of the present application;

FIG. 6 illustrates another exemplary method for hybrid positioning according to some embodiments of the present application;

FIG. 7 illustrates another exemplary method for hybrid positioning according to some embodiments of the present application; and

FIG. 8 illustrates a simplified block diagram of an exemplary apparatus for hybrid positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP 5G (i.e., new radio (NR)), 3GPP long term evolution (LTE), and so on. Persons skilled in the art know very well that, with the development of network architecture and new service scenarios, the embodiments in the present application are also applicable to similar technical problems; and moreover, the terminologies recited in the present application may change, which should not affect the principle of the present application.

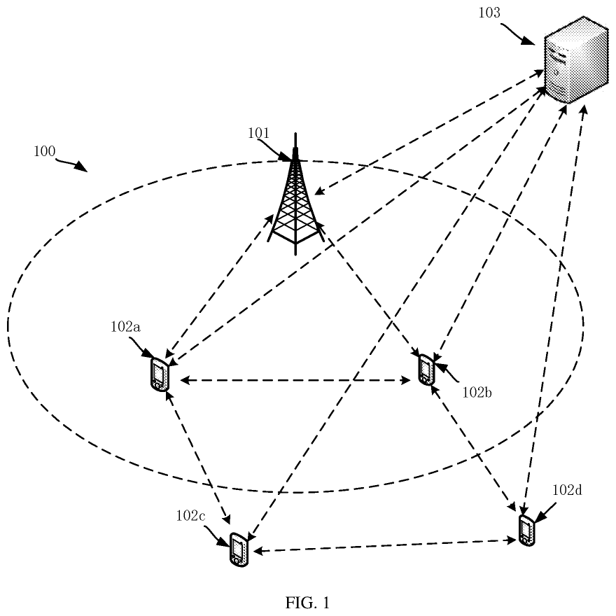

FIG. 1 is a schematic diagram illustrating an exemplary wireless communication system 100 according to some embodiments of the present application.

As shown in FIG. 1, the wireless communication system 100 includes at least one BS 101, at least one UE (e.g., a UE 102a, a UE 102b, a UE 102c, and a UE 102d), and at least one LMF 103. Although one BS, four UEs, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a transmission-reception point (TRP), a base, a macro cell, a node-B, an enhanced node B (eNB), a gNB, a home node-B, a relay node, or a device, or described using other terminology used in the art. The BS 101 is generally part of a radio access network (RAN) that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may also be referred to as a subscriber unit, a mobile, a mobile station, a user, a terminal, a mobile terminal, a wireless terminal, a fixed terminal, a subscriber station, a user terminal, or a device, or described using other terminology used in the art.

In the example illustrated in FIG. 1, both the UE 102a and the UE 102b are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC 5 interface as defined in 3GPP standard documents), and the UE 102d may communicate with the UE 102b and the UE 102c via SL.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102a, UE 102b, UE 102c, or UE 102d via LTE positioning protocol (LPP) signaling.

When a location service request associated with a UE is initiated or occurs, the position of the UE (referred to as target UE or location service (LCS) target UE) needs to be known. When the target UE is within a coverage area of a BS or network (i.e., in coverage), Uu positioning may be performed for the target UE, in which the target UE may transmit PRS(s) to or receive PRS(s) from the BS and/or neighbouring BS(s) and measurement(s) may be performed on the PRS(s) by the BS(s) or the target UE to obtain positioning information.

SL positioning refers to transmitting PRS over sidelink, which can operate independent of network or RAT coverage. According to various embodiments of the present application, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL PRS and doing relevant measurements. According to some other embodiments of the present application, the anchor UE(s) may be determined by the network (e.g., by an LMF or a BS) instead of being selected by the target UE. In such embodiments, the target UE and the anchor UE(s) may be in coverage of the network. The SL anchor UE should have positioning capability, and may be a roadside unit (RSU) or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

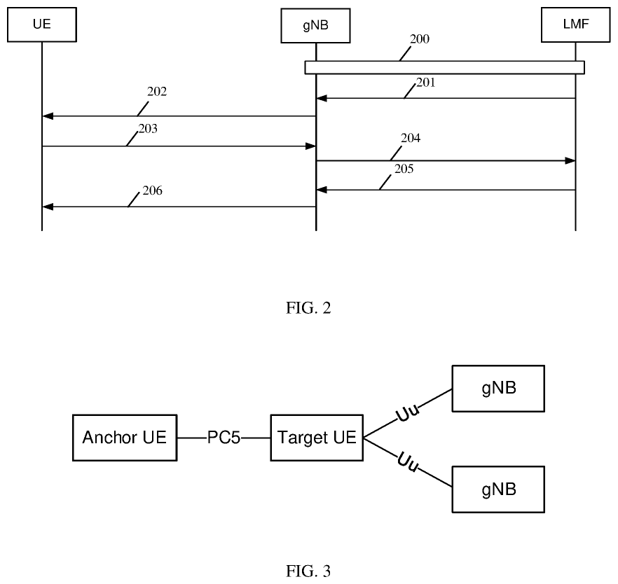

In some cases, for performing Uu positioning, a BS serving a UE may configure a PPW for the UE. FIG. 2 illustrates an exemplary procedure for configuring a PPW, which is also specified in 3GPP standard documents, e.g., TS 38.305.

Referring to FIG. 2, in step 200, an LMF may obtain TRP information required for positioning services from gNB(s).

In step 201, the LMF may provide PRS information of neighbor TRPs to a serving gNB of a UE and request the serving gNB to pre-configure PPW configuration(s) via an NRPPa MEASUREMENT PRECONFIGURATION REQUIRED message as specified in 3GPP standard documents.

In step 202, based on assistance information from the LMF and the UE capability, the serving gNB may provide pre-configured PPW configuration(s) with associated ID(s) (e.g., ID(s) of TRP(s) for positioning services) to the UE by sending an RRC RECONFIGURATION message as specified in TS 38.331.

In step 203, the UE may send an RRC RECONFIGURATION COMPLETE message as specified in TS 38.331 to the serving gNB to confirm the reception of pre-configured PPW configuration(s).

In step 204, the serving gNB may send a confirmation message to the LMF to indicate the success of the pre-configuration of PPW configuration(s) via an NRPPa MEASUREMENT PRECONFIGURATION CONFIRM message as specified in 3GPP standard documents.

In step 205, the LMF may send an NRPPa MEASUREMENT ACTIVATION message to request the serving gNB to activate or deactivate the preconfigured PPW(s).

In step 206, based on the request from the LMF in step 205, the serving gNB may send a downlink (DL) medium access control (MAC) control element (CE) PPW activation or deactivation command containing an ID to activate or deactivate the associated PPW(s).

A hybrid Uu and SL positioning may have advantages when a standalone Uu or SL positioning is not possible or cannot satisfy requirements of a positioning or location service. FIG. 3 illustrates an exemplary scenario for a hybrid Uu and SL positioning according to some embodiments of the present application.

Referring to FIG. 3, a target UE (e.g., the target UE may refer to a UE at which a location service request is initiated or occurs) is in the network coverage, and both Uu and PC5 interfaces of the target UE perform measurements of PRS. For example, as shown in FIG. 3, the target UE may perform Uu positioning with two gNBs and perform SL positioning with an anchor UE. The anchor UE may refer to a UE that participates in SL positioning and helps the target UE to acquire its position, e.g., by sending/receiving SL PRS and doing relevant measurements.

To enable a combined Uu and PC5 based positioning (or hybrid Uu and SL positioning), the coordination between Uu signaling and PC5 signaling on positioning needs to be studied, which is the main difference from a standalone Uu or SL positioning.

As an example, when a UE is performing a standalone Uu positioning, how to initiate and configure a hybrid Uu and SL positioning when the standalone Uu positioning cannot fulfill positioning requirements needs to be addressed. As another example, when a UE is performing a standalone SL positioning, how to initiate and configure a hybrid Uu and SL positioning when the standalone SL positioning cannot fulfill positioning requirements also needs to be addressed.

Given the above, embodiments of the present application provide various technical solutions for hybrid positioning, which can solve at least one of the above technical problems. For example, embodiments of the present application provide procedures and signalings for initiating and configuring a hybrid Uu and SL positioning. More details will be described in the following text in combination with the appended drawings.

### Case 1

In case 1, a UE may first perform a standalone Uu positioning and then transition to a hybrid Uu and SL positioning. The following embodiments illustrate how to initiate and configure the hybrid Uu and SL positioning when the UE is performing the standalone Uu positioning.

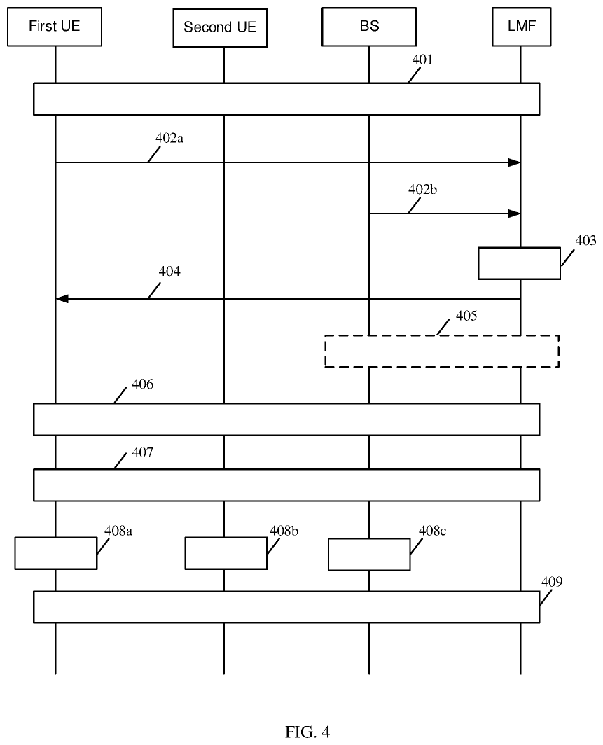

FIG. 4 illustrates an exemplary method for hybrid positioning according to some embodiments of the present application. The method illustrated in FIG. 4 may be performed by at least four network entities, e.g., a first UE, a second UE, a BS (e.g., a serving BS of the first UE), and an LMF. The first UE may be a target UE at which a location service request is initiated or occurs. In other words, the first UE may be a UE whose position needs to be known. The second UE may be an anchor UE which participates in SL positioning and helps the first UE to acquire its position, e.g., by sending/receiving SL PRS and doing relevant measurements. Although the method is illustrated in a system level, persons skilled in the art can understand that the method implemented in the four network entities can be separately implemented and incorporated in other apparatus with the like functions.

In the exemplary method shown in FIG. 4, in operation 401, the first UE, the BS, and the LMF may perform a standalone Uu positioning, in which Uu measurement(s) of PRS may be performed by the first UE and/or at least one BS for performing Uu positioning for the first UE. The at least one BS for performing Uu positioning may include at least one of the serving BS of the UE or one or more other BSs (not shown in FIG. 4).

In operation 402a, the first UE may transmit first Uu measurement information associated with the position of the first UE to the LMF. For example, the first Uu measurement information may include measurement result(s) obtained by the first UE based on Uu PRS. For example, the first Uu measurement information may be included in a first Uu measurement report to the LMF. Alternatively or additionally, in operation 402b, the at least one BS for performing Uu positioning for the first UE may transmit second Uu measurement information associated with the position of the first UE to the LMF. For example, the second Uu measurement information from a BS may include measurement result(s) obtained by the BS based on Uu PRS. For example, the second Uu measurement information may be included in a second Uu measurement report to the LMF. In other words, the LMF may receive at least one of the first Uu measurement information from the first UE or the second Uu measurement information from the at least one BS for performing Uu positioning for the first UE.

In operation 403, the LMF may determine whether to initiate a hybrid positioning procedure based on at least one of the first Uu measurement information or the second Uu measurement information. The hybrid positioning procedure may include a hybrid Uu and SL positioning procedure, which is also referred to as a hybrid Uu and PC5 positioning procedure, a combined Uu and PC5 based positioning procedure, a hybrid Uu+PC5 positioning procedure, or the like.

For example, the LMF may determine to initiate a hybrid positioning procedure in response to at least one of:
a position estimation of the first UE computed based on the at least one of the first Uu measurement information or the second Uu measurement information failing to satisfy a QoS requirement of a positioning service; or
the at least one of the first Uu measurement information or the second Uu measurement information indicating a failure of Uu measurement: for example, Uu measurement information received by the LMF may include a failure cause which indicates a failure of Uu measurement of PRS.

In the case that the LMF determines to initiate a hybrid positioning procedure, in operation 404, the LMF may transmit, to the first UE, a first request indicating the first UE to perform a hybrid Uu and SL positioning. In some embodiments, the first request may indicate to the first UE for obtaining measurement information associated with a position of the first UE.

In some embodiments, the first request may include at least one of: information of at least one second UE for performing SL positioning for the first UE; a second request indicating the first UE to discover second UE(s) for performing SL positioning for the first UE; or an updated Uu positioning configuration.

As an example, if the LMF has determined second UE(s) for performing SL positioning for the first UE, the first request may include information of the determined second UE(s) for performing SL positioning for the first UE.

As another example, if the LMF has not determined second UE(s) for performing SL positioning for the first UE, the first request may include a second request indicating the first UE to discover second UE(s) for performing SL positioning for the first UE.

As an example, if the Uu positioning configuration needs to be updated, the first request may also include an updated Uu positioning configuration. The updated Uu positioning configuration may include necessary configuration update(s) of Uu positioning, e.g., updated information of BS(s) for performing Uu positioning for the first UE (e.g., BS(s) to be participate in the Uu positioning for the first UE).

In some embodiments, if the Uu positioning configuration needs to be updated, in operation 405, the LMF may trigger BS(s) involved for the Uu positioning to update the Uu positioning configuration. As an example, for at least one BS which performs the Uu positioning after the hybrid positioning procedure is initiated, the LMF may transmit the updated Uu positioning configuration to the at least one BS. As another example, if a BS is no longer required to participate in the Uu positioning, the LMF may indicate the BS to abort its Uu positioning configuration, e.g., the LMF may transmit, to the BS, a message indicating the BS to abort its Uu positioning configuration.

In the case that the first request includes the information of at least one second UE, after receiving the first request, in operation 406, the first UE may discover the at least one second UE with or without the assistance of the LMF and establish an SL connection with the at least one second UE.

In the case that the first request includes the second request indicating the first UE to discover second UE(s), after receiving the first request, in operation 406, the first UE may discover a set of candidate second UEs, and select one or more second UEs from the set of candidate second UEs for establishing SL connection(s) with the one or more second UEs, with or without the assistance of the LMF.

In some embodiments, in operation 406, the first UE may transmit a response to the LMF. In some examples, the response may indicate a confirmation of the first request. Alternatively or additionally, the response may indicate one or more second UEs selected by the first UE for performing SL positioning for the first UE.

In operation 407, the LMF may transmit an updated positioning configuration to the first UE. For example, responsive to the first request being transmitted from the LMF, and in the case that a Uu positioning configuration and an SL positioning configuration of the first UE are not operationally aligned, the LMF may transmit an updated positioning configuration to the first UE for the first UE to obtain the measurement information associated with the position of the first UE. In some examples, a Uu positioning configuration and an SL positioning configuration of the first UE being not operationally aligned may include that a Uu PPW for Uu positioning and an SL PPW for SL positioning are not aligned. In some examples, a Uu positioning configuration and an SL positioning configuration of the first UE being not operationally aligned may include that the first UE is not configured with an SL positioning configuration. In some examples, the updated positioning configuration may include an SL positioning configuration, e.g., configuration regarding SL PRS, configuration regarding measurement and report, etc.

Accordingly, in operation 407, the first UE may obtain an updated positioning configuration. For example, responsive to the first request being received from the LMF, and in the case that a Uu positioning configuration and an SL positioning configuration of the first UE are not operationally aligned, the first UE may obtain an updated positioning configuration for obtaining the measurement information associated with the position of the first UE.

In some embodiments, obtaining an updated positioning configuration by the first UE may include obtaining an SL positioning configuration from the LMF. As will be described later, the first UE may additionally or alternatively obtain some SL positioning configuration (e.g., SL PPW configuration) by receiving the SL positioning configuration from its serving BS or determining the SL positioning configuration by itself. Accordingly, obtaining an updated positioning configuration by the first UE may also include receiving the SL positioning configuration from its serving BS or determining the SL positioning configuration by itself. In some embodiments, both the SL positioning configuration obtained in operation 407 and the updated Uu positioning configuration that may be obtained from the first request can be referred to as a hybrid positioning configuration or an updated positioning configuration.

In operation 408a, the first UE may perform at least one of: Uu PRS transmission; Uu PRS reception, Uu PRS measurement; SL PRS transmission; SL PRS reception, or SL PRS measurement based on the updated positioning configuration. In some examples, the first UE may obtain the measurement information associated with the position of the first UE using the updated positioning configuration. The measurement information may include at least one of Uu measurement information (e.g., measurement result(s) of Uu PRS) or SL measurement information (e.g., measurement result(s) of SL PRS).

In step 408b, the second UE(s) which performs SL positioning for the first UE may perform at least one of: SL PRS transmission; SL PRS reception, or SL PRS measurement. In some examples, the second UE(s) may obtain the measurement information associated with the position of the first UE using an SL positioning configuration. The measurement information may include SL measurement information (e.g., measurement results of SL PRS).

In step 408c, the BS(s) which performs Uu positioning for the first UE may perform at least one of: Uu PRS transmission; Uu PRS reception, or Uu PRS measurement. In some examples, the BS(s) may obtain the measurement information associated with the position of the first UE using a Uu positioning configuration or updated Uu positioning configuration. The measurement information may include Uu measurement information (e.g., measurement result(s) of Uu PRS).

After Uu and/or SL measurement information are obtained, in operation 409, Uu and/or SL measurement information may be transmitted to a calculating node for calculating a position estimation of the first UE. The calculating node may be the first UE, a second UE which performs SL positioning for the first UE, a BS (e.g., the serving BS of the first UE) which performs Uu positioning for the first UE, or the LMF. For example, at least one of the first UE, the second UE(s) for performing SL positioning for the first UE, or the BS(s) for performing Uu positioning for the first UE may transmit the obtained measurement information to the calculating node for determining the position of the first UE. In some embodiments, the measurement information obtained by the first UE, the second UE(s), or the BS(s) may be included in measurement report(s) to the calculating node. In some cases, the above procedure illustrated in FIG. 4 may have a latency problem because the hybrid Uu and SL positioning is initiated only after the LMF receives the Uu measurement information from the first UE and/or the BS(s) which perform the Uu positioning for the first UE. Such procedure may be accelerated by initiating the hybrid Uu and SL positioning in the process of the Uu positioning, e.g., before transmitting the Uu measurement information, the first UE and/or the BS(s) may transmit assistance data to the LMF when some (pre)configured conditions are satisfied. The following embodiments illustrate how to use the (pre)configured conditions to reduce a latency of the procedure in FIG. 4.

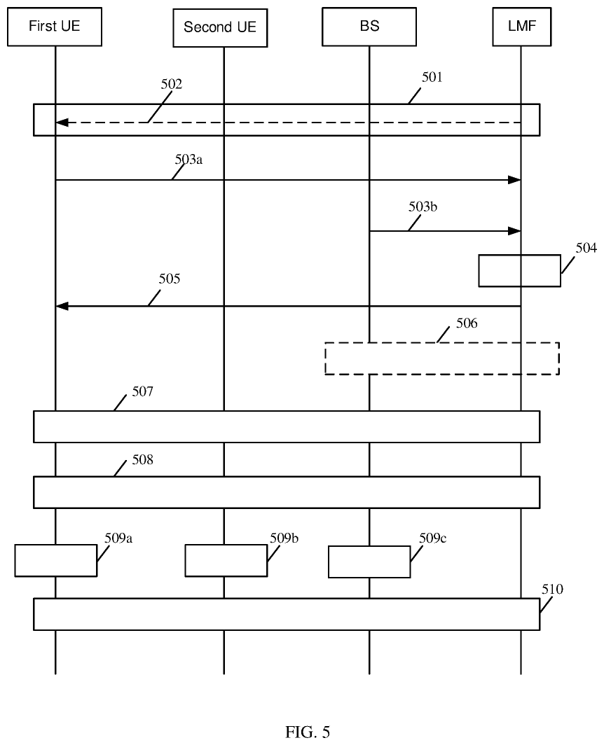

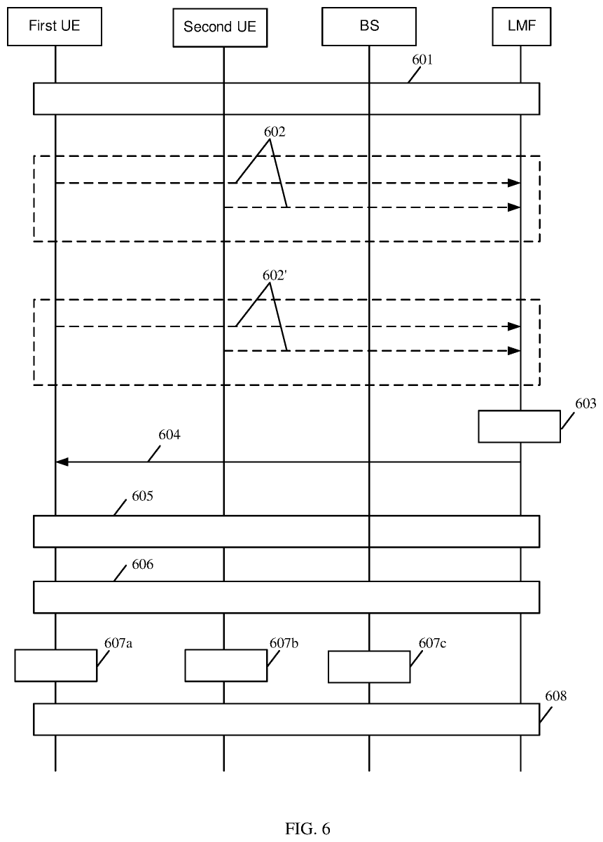

FIG. 5 illustrates an exemplary method for hybrid positioning according to some embodiments of the present application. The method illustrated in FIG. 5 may be performed by at least four network entities, e.g., a first UE, a second UE, a BS (e.g., a serving BS of the first UE), and an LMF. The first UE may be a target UE at which a location service request is initiated or occurs. In other words, the first UE may be a UE whose position needs to be known. The second UE may be an anchor UE which participates in SL positioning and helps the first UE to acquire its position, e.g., by sending/receiving SL PRS and doing relevant measurements. Although the method is illustrated in a system level, persons skilled in the art can understand that the method implemented in the four network entities can be separately implemented and incorporated in other apparatus with the like functions.

In the exemplary method shown in FIG. 5, operation 501 may be the same as operation 401.

In operation 502, the LMF may transmit (e.g., configure or pre-configure) first condition(s) to the first UE. Consequently, the first UE may receive the first condition(s) from the LMF. In some embodiments, the first condition(s) may be configured or pre-configured by the LMF to the first UE during operation 501 (i.e., during the standalone Uu positioning), as shown in FIG. 5. That is, operation 502 may be part of operation 501. In some other embodiments, the first condition(s) may be configured or pre-configured by the LMF to the first UE independent of operation 501 (e.g., before or after operation 501).

In some embodiments, the first condition(s) may include:
a link quality of at least one Uu connection is lower than a first pre-defined threshold during a time window, while a link quality of at least one other Uu connection is higher than a second pre-defined threshold during the time window; and
at least one SL connection can be established and a link quality of the at least one SL connection is higher than a third pre-defined threshold during the time window.

The first, second, and third pre-defined thresholds mentioned above may be the same or different, and may be configured or pre-configured by the LMF. In addition, the length of the time window mentioned above may also be configured or pre-configured by the LMF.

In response to that the first condition(s) is satisfied, the first UE may transmit a first assistance data to the LMF in operation 503a. For example, the first assistance data may be transmitted by a RequestAssistanceData message or ProvideLocationInformation message as specified in 3GPP standard documents, or may be transmitted by any other new message.

The first assistance data may indicate that the first condition(s) is satisfied. Alternatively or additionally, if the first UE has already discovered at least one second UE for performing SL positioning for the first UE, the first assistance data may include the at least one second UE for performing SL positioning for the first UE and a link quality (e.g., reference signal receiving power (RSRP) of PRS, etc.) of an SL connection between each of the at least one second UE and the first UE.

In some embodiments, in operation 503b, at least one BS for performing Uu positioning for the first UE may transmit a second assistance data to the LMF. The second assistance data may indicate that second condition(s) at the at least one BS is satisfied. The at least one BS for performing Uu positioning may include at least one of the serving BS of the UE or one or more other BSs (not shown in FIG. 5).

For example, a BS for performing Uu positioning for the first UE may transmit a second assistance data to the LMF in response to that second condition(s) at the BS is satisfied. The second assistance data may indicate that the second condition(s) at the BS is satisfied. The second condition(s) at the BS to trigger the second assistance data transfer may be up to the BS's implementation. For example, the second condition(s) at the BS may include that a link quality of a Uu connection between the BS and the first UE is lower than a threshold during a time window, e.g., a signal quality of a line of sight (LOS) signal measured by the BS is lower than a threshold during a time window. In such examples, the threshold and the time window may be determined by the BS itself.

Consequently, the LMF may receive at least one of the first assistance data or the second assistance data.

In operation 504, the LMF may determine to initiate a hybrid positioning procedure based on at least one of the first assistance data or the second assistance data. Then, the LMF, the first UE, second UE(s) for performing SL positioning for the first UE, and BS(s) for performing Uu positioning for the first UE may perform operations 505, 506, 507, 508, 509a, 509b, 509c, and 510, which are the same as operations 404, 405, 406, 407, 408a, 408b, 408c, and 409 illustrated in FIG. 4, respectively.

In some embodiments, the LMF may also receive Uu measurement information from the first UE or BS(s) for performing Uu positioning for the first UE. However, such Uu measurement information may be received after reception of the at least one of the first assistance data or the second assistance data, and the LMF may determine whether to initiate a hybrid positioning procedure even before receiving the Uu measurement information.

In some cases, for the hybrid Uu and SL positioning, if measurement reports over sidelink and over Uu link are not aligned, the two types of measurement reports may not be matched to the same location of the first UE. This problem may be solved by configuring an SL PPW (also referred to as SL measurement window) which aligns with the Uu PPW. The following embodiments provide serval solutions for configuring an SL PPW which aligns with the Uu PPW.

### Solution 1

In solution 1, the SL PPW may be determined by the first UE. For example, the first UE may receive, from the serving BS of the first UE, information of a Uu PPW which will be used in the hybrid Uu and SL positioning. For example, the information of the Uu PPW may be transmitted by the serving BS to the first UE in a radio resource control (RRC) reconfiguration message as specified in 3GPP standard documents. Then, the first UE may determine an SL PPW aligned with the Uu PPW based at least in part on the information of the Uu PPW. In some examples, the SL PPW may also be determined based on information of second UE(s) for performing SL positioning for the first UE. The SL PPW may be used by the first UE and/or second UE(s) for performing SL positioning for the first UE. In some examples, if the second UE(s) for performing SL positioning for the first UE needs to know the SL PPW (e.g., in the case of the second UE(s) performing SL PRS measurement), the first UE may transmit assistance data indicating the SL PPW to the second UE(s).

### Solution 2

In solution 2, the serving BS of the first UE may obtain information related to an SL positioning for the first UE. Then the BS may determine an SL PPW based at least in part on the information related to the SL positioning for the first UE.

In some embodiments, the information related to the SL positioning for the first UE may include information of second UE(s) for performing SL positioning for the first UE.

For example, the LMF may transmit information of second UE(s) for performing SL positioning for the first UE to the serving BS of the first UE. Then, the serving BS may determine an SL PPW which aligns with a Uu PPW configured for the first UE based at least in part on the information of the second UE(s). After that, the serving BS may transmit information of the determined SL PPW to at least one of the first UE or the second UE(s) for performing SL positioning for the first UE.

In some cases, for a second UE which is out of the coverage of the serving BS of the first UE, the serving BS may provide the information of the determined SL PPW to the second UE via the first UE. That is, the first UE may first receive the information of the determined SL PPW from the serving BS and then transmit it to the second UE.

### Solution 3

In solution 3, the serving BS of the first UE may transmit information of a Uu PPW to the LMF. After receiving the information, the LMF may transmit the information of the Uu PPW and information of second UE(s) for performing SL positioning for the first UE to at least one serving BS of at least one second UE of the second UE(s). The at least one second UE may perform SL PRS measurement. Then, the at least one serving BS of the at least one second UE may determine an SL PPW for the at least one second UE and transmit the determined SL PPW to the at least one second UE. For example, the SL PPW may be determined based at least in part on the Uu PPW. In some examples, the SL PPW may also be determined based on the information of second UE(s) for performing SL positioning for the first UE. The determined SL PPW aligns with the Uu PPW indicated by the information received from the LMF.

Solution 3 is applicable to a situation where only second UE(s) for performing SL positioning for the first UE will perform measurement over sidelink after the hybrid Uu and SL positioning is initiated and the second UE(s) is out of coverage of the serving BS of the first UE.

### Solution 4

In solution 4, the serving BS of the first UE may transmit information of a Uu PPW to the LMF. After receiving the information, the LMF may determine an SL PPW based at least in part on the information of the Uu PPW, wherein the SL PPW aligns with the Uu PPW. In some examples, the SL PPW may also be determined based on information of second UE(s) for performing SL positioning for the first UE. After that, the LMF may transmit information of the determined SL PPW (e.g., as assistance data) to at least one of the first UE or the second UE(s) for performing SL positioning for the first UE.

In some cases, for a second UE which is out of network coverage, the LMF may provide the information of the determined SL PPW to the second UE via the first UE. That is, the first UE may first receive the information of the determined SL PPW from the LMF and then transmit it to the second UE.

In the above solutions 1-4, the information of the SL PPW may be a part of the SL positing configuration obtained by the first UE in operation 407 in FIG. 4 or operation 508 in FIG. 5. That is, the first UE obtaining the SL positing configuration in operation 407 in FIG. 4 or operation 508 in FIG. 5 may include obtaining the information of the SL PPW in accordance with the above solutions 1-4.

### Case 2

In case 2, a UE may first perform a standalone SL positioning and then transition to a hybrid Uu and SL positioning. The following embodiments illustrate how to initiate and configure the hybrid Uu and SL positioning when the UE is performing the standalone SL positioning.

FIG. 6 illustrates another exemplary method for hybrid positioning according to some embodiments of the present application. The method illustrated in FIG. 6 may be performed by at least four network entities, e.g., a first UE, a second UE, a BS (e.g., a serving BS of the UE), and an LMF. The first UE may be a target UE at which a location service request is initiated or occurs. In other words, the first UE may be a UE whose position needs to be known. The second UE may be an anchor UE which participates in SL positioning and helps the first UE to acquire its position, e.g., by sending/receiving SL PRS and doing relevant measurements. Although the method is illustrated in a system level, persons skilled in the art can understand that the method implemented in the four network entities can be separately implemented and incorporated in other apparatus with the like functions.

In the exemplary method shown in FIG. 6, in operation 601, the first UE, one or more second UE(s), and the LMF may perform a standalone SL positioning, in which SL measurement(s) of PRS may be performed by the first UE and/or the one or more second UE(s) for performing SL positioning for the first UE. For simplicity, FIG. 6 only illustrates one second UE for performing SL positioning for the first UE. In fact, one or more second UEs may perform SL positioning for the first UE.

In some embodiments of FIG. 6, the LMF may be responsible to calculate a position estimation of the first UE. In such embodiments, the first UE and the second UE(s) for performing SL positioning for the first UE may perform operation 602. In operation 602, at least one of the first UE or the second UE(s) for performing SL positioning for the first UE may transmit SL measurement information associated with the position of the first UE to the LMF. For example, in operation 602, the first UE may transmit SL measurement information to the LMF. For example, the SL measurement information may include measurement result(s) obtained by the first UE based on SL PRS. For example, the SL measurement information may be included in an SL measurement report to the LMF. Alternatively or additionally, in operation 602, the second UE(s) may transmit SL measurement information to the LMF. For example, the SL measurement information from a second UE may include measurement result(s) obtained by the second UE based on SL PRS. For example, the SL measurement information may be included in an SL measurement report to the LMF. In some examples, the SL measurement information may indicate a failure of SL measurement. For example, the SL measurement information may include a failure cause from involved UE(s), indicating a failure of SL measurement of PRS.

Consequently, the LMF may receive SL measurement information from at least one of the first UE or the second UE(s) for performing SL positioning for the first UE.

In operation 603, the LMF may determine whether to initiate a hybrid positioning procedure based on the received SL measurement information. For example, the LMF may determine to initiate a hybrid positioning procedure in response to at least one of: a position estimation of the first UE computed based on the received SL measurement information failing to satisfy a QoS requirement of a positioning service, or the received SL measurement information indicating a failure of SL measurement.

In some other embodiments, at least one of the first UE or the second UE(s) for performing SL positioning for the first UE may be responsible to calculate the position estimation of the first UE. In such embodiments, the first UE and the second UE(s) for performing SL positioning for the first UE may perform operation 602′. In operation 602′, at least one of the first UE or the second UE(s) for performing SL positioning for the first UE may transmit a third assistance data to the LMF in response to finding at least one of: a position estimation of the first UE computed based on SL measurement information failing to satisfy a QoS requirement of a positioning service; or a failure of SL measurement. For example, in operation 602′, the first UE may transmit a third assistance data to the LMF in response to finding at least one of the above situations; alternatively or additionally, in operation 602′, the second UE(s) may transmit a third assistance data to the LMF in response to finding at least one of the above situations. In some examples, the third assistance data transmitted by the at least one of the first UE or the second UE(s) may indicate at least one of: a position estimation of the first UE computed based on SL measurement information failing to satisfy a QoS requirement of a positioning service; or a failure of SL measurement.

In such embodiments, in operation 603, the LMF may determine to initiate a hybrid positioning procedure based on the third assistance data.

In the case that the LMF determines to initiate a hybrid positioning procedure, in operation 604, the LMF may transmit, to the first UE, a first request indicating the first UE to perform a hybrid Uu and SL positioning. In some embodiments, the first request may indicate to the first UE for obtaining measurement information associated with a position of the first UE.

In some embodiments, the first request may include at least one of: information of BS(s) for performing Uu positioning for the first UE; updated information of second UE(s) for performing SL positioning for the first UE; or a third request indicating the first UE to reselect second UE(s) for performing SL positioning for the first UE.

In some embodiments, if the first request includes the third request indicating the first UE to reselect second UE(s) for performing SL positioning for the first UE, in step 605, the first UE may reselect one or more second UEs for performing SL positioning for the first UE. In other words, the LMF may trigger or the first UE may perform a procedure for reselecting second UE(s) in the case that the first request includes the third request indicating the first UE to reselect second UE(s).

In some embodiments, in operation 605, the first UE may transmit a response to the LMF. In some examples, the response may indicate a confirmation of the first request. Alternatively or additionally, the response may include one or more second UEs reselected by the first UE for performing SL positioning for the first UE.

In operation 606, the LMF may transmit an updated positioning configuration to the first UE. For example, responsive to the first request being transmitted from the LMF, and in the case that a Uu positioning configuration and an SL positioning configuration of the first UE are not operationally aligned, the LMF may transmit an updated positioning configuration to the first UE for the first UE to obtain the measurement information associated with the position of the first UE. In some examples, a Uu positioning configuration and an SL positioning configuration of the first UE being not operationally aligned may include that a Uu PPW for Uu positioning and an SL PPW for SL positioning are not aligned. In some examples, a Uu positioning configuration and an SL positioning configuration of the first UE being not operationally aligned may include that the first UE is not configured with a Uu positioning configuration. In some examples, the updated positioning configuration may include a Uu positioning configuration, e.g., information of BS(s) for performing Uu positioning, configuration regarding Uu PRS, configuration regarding measurement and report, etc. In the cases that a procedure for reselecting second UE(s) is performed by the first UE, the updated positioning configuration (also referred to as hybrid positioning configuration) may also include an SL positioning configuration (e.g., an updated SL positioning configuration).

Accordingly, in operation 606, the first UE may obtain an updated positioning configuration. For example, responsive to the first request being received from the LMF, and in the case that a Uu positioning configuration and an SL positioning configuration of the first UE are not operationally aligned, the first UE may obtain an updated positioning configuration for obtaining the measurement information associated with the position of the first UE.

In some embodiments, obtaining an updated positioning configuration by the first UE may include obtaining the updated positioning configuration from the LMF. As will be described later, the first UE may additionally or alternatively obtain some Uu positioning configuration (e.g., Uu PPW configuration) by receiving the Uu positioning configuration from its serving BS. Accordingly, obtaining an updated positioning configuration by the first UE may also include receiving the Uu positioning configuration from its serving BS.

In operation 607a, the first UE may perform at least one of: Uu PRS transmission; Uu PRS reception, Uu PRS measurement; SL PRS transmission; SL PRS reception, or SL PRS measurement based on the updated positioning configuration. In some examples, the first UE may obtain the measurement information associated with the position of the first UE using the updated positioning configuration. The measurement information may include at least one of Uu measurement information (e.g., measurement result(s) of Uu PRS) or SL measurement information (e.g., measurement result(s) of SL PRS).

In step 607b, the second UE(s) which performs SL positioning for the first UE may perform at least one of: SL PRS transmission; SL PRS reception, or SL PRS measurement. In some examples, the second UE(s) may obtain the measurement information associated with the position of the first UE using an SL positioning configuration or updated SL positioning configuration. The measurement information may include SL measurement information (e.g., measurement result(s) of SL PRS).

In step 607c, the BS(s) which performs Uu positioning for the first UE may perform at least one of: Uu PRS transmission; Uu PRS reception, or Uu PRS measurement. In some examples, the BS(s) may obtain the measurement information associated with the position of the first UE using a Uu positioning configuration. The measurement information may include Uu measurement information (e.g., measurement result(s) of Uu PRS).

After Uu and/or SL measurement information are obtained, in operation 608, Uu and/or SL measurement information may be transmitted to a calculating node for calculating a position estimation of the first UE. The calculating node may be the first UE, a second UE which performs SL positioning for the first UE, a BS (e.g., the serving BS of the first UE) which performs Uu positioning for the first UE, or the LMF. For example, at least one of the first UE, the second UE(s) for performing SL positioning for the first UE, or the BS(s) for performing Uu positioning for the first UE may transmit the obtained measurement information to the calculating node for determining the position of the first UE. In some embodiments, the measurement information obtained by the first UE, the second UE(s), or the BS(s) may be included in measurement report(s) to the calculating node.

In some cases, the above procedure illustrated in FIG. 6 may have a latency problem because the hybrid Uu and SL positioning is initiated only after the LMF receives the SL measurement information or the third assistance data from the first UE and/or the second UE(s) for performing the SL positioning for the first UE. Such procedure may be accelerated by initiating the hybrid Uu and SL positioning in the process of the SL positioning, e.g., before transmitting the SL measurement information, the first UE may transmit assistance data to the LMF when some (pre)configured conditions are satisfied. The following embodiments illustrate how to use the (pre)configured conditions to reduce a latency of the procedure in FIG. 6.

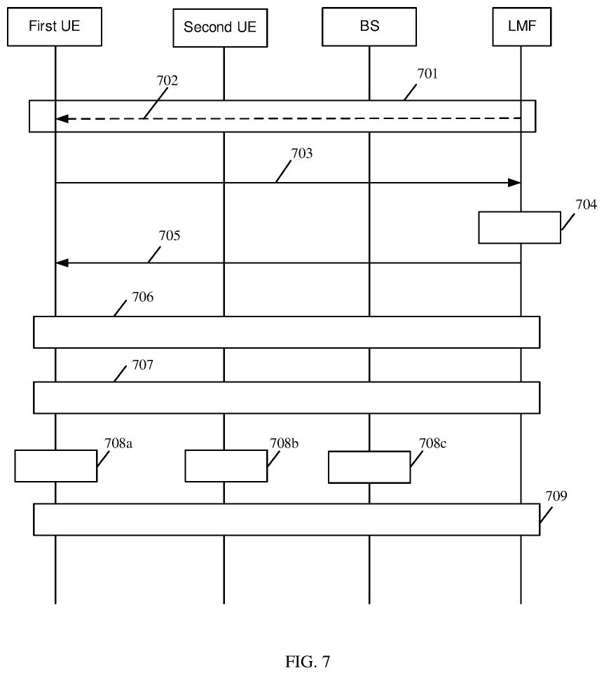

FIG. 7 illustrates another exemplary method for hybrid positioning according to some embodiments of the present application. The method illustrated in FIG. 7 may be performed by at least four network entities, e.g., a first UE, a second UE, a BS (e.g., a serving BS of the UE), and an LMF. The first UE may be a target UE at which a location service request is initiated or occurs. In other words, the first UE may be a UE whose position needs to be known. The second UE may be an anchor UE which participates in SL positioning and helps the first UE to acquire its position, e.g., by sending/receiving SL PRS and doing relevant measurements. Although the method is illustrated in a system level, persons skilled in the art can understand that the method implemented in the four network entities can be separately implemented and incorporated in other apparatus with the like functions.

In the exemplary method shown in FIG. 7, operation 701 may be the same as operation 601.

In operation 702, the LMF may transmit (e.g., configure or pre-configure) second condition(s) to the first UE. Consequently, the first UE may receive the second condition(s) from the LMF. In some embodiments, the second condition(s) may be configured or pre-configured by the LMF to the first UE during operation 701 (i.e., during the standalone SL positioning), as shown in FIG. 7. That is, operation 702 may be part of operation 701. In some other embodiments, the second condition(s) may be configured or pre-configured by the LMF to the first UE independent of operation 701 (e.g., before or after operation 701).

In some embodiments, the second condition(s) may include:
a link quality of at least one SL connection associated with at least one second UE is lower than a fourth pre-defined threshold during a time window and the first UE cannot find one or more second UEs to replace the at least one second UE for performing SL positioning for the first UE during the time window, while a link quality of one or more other SL connections is higher than a fifth pre-defined threshold during the time window, wherein a number of the one or more other SL connections is no more than a requested number (e.g., the number of SL connections requested by the LMF for satisfying requirements of a positioning service); and
at least one Uu connection can be established and a link quality of the at least one Uu connection is higher than a sixth pre-defined threshold during the time window.

The fourth, fifth, sixth pre-defined thresholds described above may be the same or different, and may be configured or pre-configured by the LMF. In addition, the length of the time window mentioned above may also be configured or pre-configured by the LMF.

In response to that the second condition(s) is satisfied, the first UE may transmit a fourth assistance data to the LMF in operation 703. For example, the fourth assistance data may be transmitted by a RequestAssistanceData message or ProvideLocationInformation message as specified in 3GPP standard documents, or may be transmitted by any other new message. The fourth assistance data may indicate that the second condition(s) is satisfied. Consequently, in step 603, the LMF may receive the fourth assistance data from the first UE.

In operation 704, the LMF may determine to initiate a hybrid positioning procedure based on the fourth assistance data. Then, the LMF, the first UE, second UE(s) for performing SL positioning for the first UE, and the BS(s) for performing Uu positioning for the first UE may perform operations 705, 706, 707, 708a, 708b, 708c, and 709, which are the same as operations 604, 605, 606, 607a, 607b, 607c, and 608 illustrated in FIG. 6, respectively.

In some embodiments, the LMF may also receive SL measurement information or the third assistance data from the first UE or second UE(s) for performing Uu positioning for the first UE. However, the SL measurement information or the third assistance data may be received after reception of the fourth assistance data, and the LMF may determine whether to initiate a hybrid positioning procedure even before receiving the SL measurement information or the third assistance data.

In some cases, for the hybrid Uu and SL positioning, if measurement reports over sidelink and over Uu link are not aligned, the two types of measurement reports may not be matched to the same location of the first UE. This problem may be solved by configuring a Uu PPW which aligns with the SL PPW.

In such cases, the serving BS of the first UE may obtain information related to an SL positioning for the first UE. Then, the serving BS may determine at least one of a Uu PPW or an SL PPW based at least in part on the information related to the SL positioning for the first UE. After that, the serving BS may transmit information of the determined at least one of the Uu PPW or the SL PPW to at least one of the first UE or second UE(s) for performing SL positioning for the first UE. Specifically, the following embodiments provide serval solutions for configuring a Uu PPW which aligns with an SL PPW.

### Solution 1′

In solution 1′, the first UE may transmit information of an SL PPW to the serving BS of the first UE. In solution 1′, the information related to an SL positioning for the first UE may include the information of the SL PPW from the first UE.

After receiving the information of the SL PPW, the serving BS of the first UE may determine a Uu PPW which aligns with the SL PPW indicated by the information of the SL PPW. For example, the Uu PPW may be determined based at least in part on the SL PPW. In some examples, the Uu PPW may also be determined based on information of BS(s) for performing Uu positioning for the first UE. After that, the serving BS may transmit information of the determined Uu PPW to the first UE. In some examples, the serving BS may transmit information of the determined Uu PPW and associated ID(s) (e.g., the ID(s) of TRP(s)) to the first UE. In some examples, the information of the determined Uu PPW (and associated ID(s) in some cases) may be transmitted in an RRC reconfiguration message from the serving BS to the first UE.

### Solution 2′

In solution 2′, a serving BS of a second UE which preforms the standalone SL positioning for the first UE may transmit information of the SL PPW to the serving BS of the first UE. In solution 2′, the information related to the SL positioning may include the information of the SL PPW from the first UE.

After receiving the information of the SL PPW, the serving BS of the first UE may determine a Uu PPW which aligns with the SL PPW indicated by the information of the SL PPW. For example, the Uu PPW may be determined based at least in part on the SL PPW. In some examples, the Uu PPW may also be determined based on information of BS(s) for performing Uu positioning for the first UE. After that, the serving BS may transmit information of the determined Uu PPW to the first UE. In some examples, the serving BS may transmit information of the determined Uu PPW and associated ID(s) (e.g., the ID(s) of TRP(s)) to the first UE. In some examples, the information of the determined Uu PPW (and associated ID(s) in some cases) may be transmitted in an RRC reconfiguration message from the serving BS to the first UE.

Solution 2′ is applicable to a situation where only second UE(s) for performing SL positioning for the first UE performs measurement over sidelink before the hybrid Uu and SL positioning is initiated, and the second UE(s) is out of coverage of the serving BS of the first UE.

### Solution 3′

In some embodiments of solution 3′, the SL PPW for the standalone SL positioning before the hybrid Uu and SL positioning may be determined by the serving BS of the first UE. In such embodiments, the serving BS of the first UE may determine a Uu PPW which aligns with the SL PPW determined by the serving BS of the first UE. For example, the Uu PPW may be determined based at least in part on the SL PPW. In some examples, the Uu PPW may also be determined based on information of BS(s) for performing Uu positioning for the first UE. After that, the serving BS may transmit information of the determined Uu PPW to the first UE. In some examples, the serving BS may transmit the information of the determined Uu PPW and associated ID(s) (e.g., the ID(s) of TRP(s)) to the first UE. In some examples, the information of the determined Uu PPW (and associated ID(s) in some cases) may be transmitted in an RRC reconfiguration message from the serving BS to the first UE.

In some other embodiments of solution 3′, the first UE may perform a procedure for reselecting second UE(s) as stated above. In such embodiments, the LMF may transmit the updated information of second UE(s) for performing SL positioning for the first UE to the serving BS of the first UE. In such embodiments, the information related to SL positioning for the first UE includes the updated information of second UE(s) for performing SL positioning for the first UE. After receiving such information, the serving BS of the first UE may determine a Uu PPW and an SL PPW based at least in part on the updated information of second UE(s), wherein the Uu PPW aligns with the SL PPW. In some examples, the Uu PPW and the SL PPW may also be determined based on information of BS(s) for performing Uu positioning for the first UE. Then, the serving BS of the first UE may transmit information of the determined Uu PPW to the first UE. In some examples, the serving BS may transmit the information of the determined Uu PPW and associated ID(s) (e.g., the ID(s) of TRP(s)) to the first UE. In some examples, the information of the determined Uu PPW (and associated ID(s) in some cases) may be transmitted in an RRC reconfiguration message from the serving BS to the first UE. In some examples, the serving BS of the first UE may also transmit information of the determined SL PPW (e.g., as assistance data) to at least one of the first UE or the second UE(s).

In some cases, for a second UE which is out of network coverage, the serving BS may provide the information of the determined SL PPW to the second UE via the first UE. That is, the first UE may first receive the information of the determined SL PPW from the serving BS and then transmit it to the second UE.

### Solution 4′

In solution 4′, the SL PPW used in SL positioning for the first UE may be determined by the LMF, and the LMF may transmit information of the SL PPW to the serving BS of the first UE, e.g., in a request of Uu PPW configuration. In solution 4′, the information related to the SL positioning may include the information of the SL PPW from the LMF.

After receiving the information of the SL PPW, the serving BS of the first UE may determine a Uu PPW which aligns with the SL PPW indicated by the information of SL PPW. For example, the Uu PPW may be determined based at least in part on the SL PPW. In some examples, the Uu PPW may also be determined based on information of BS(s) for performing Uu positioning for the first UE. After that, the serving BS may transmit information of the determined Uu PPW to the first UE. In some examples, the serving BS may transmit information of the determined Uu PPW and associated ID(s) (e.g., the ID(s) of TRP(s)) to the first UE. In some examples, the information of the determined Uu PPW (and associated ID(s) in some cases) may be transmitted in an RRC reconfiguration message from the serving BS to the first UE.

In the above solutions 1′-4′, the information of the SL PPW and the information of the Uu PPW may be a part of the updated positioning configuration obtained by the first UE in operation 606 in FIG. 6 or operation 707 in FIG. 7. That is, the first UE obtaining the updated positing configuration in operation 606 in FIG. 6 or operation 707 in FIG. 7 may include obtaining at least one of the information of the SL PPW or the information of the Uu PPW in accordance with the above solutions 1′-4′.

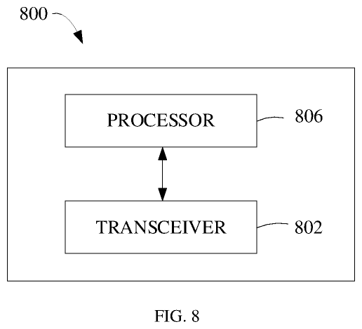

FIG. 8 illustrates a simplified block diagram of an exemplary apparatus for hybrid positioning according to some embodiments of the present application. In some embodiments, the apparatus 800 may be or include at least part of a first UE, e.g., a target UE as stated above. In some embodiments, the apparatus 800 may be or include at least part of a second UE, e.g., an anchor UE as stated above. In some other embodiments, the apparatus 800 may be or include at least part of a BS, e.g., a serving BS of the first UE. In some other embodiments, the apparatus 800 may be or include at least part of an LMF of a wireless network.

Referring to FIG. 8, the apparatus 800 may include at least one transceiver 802 and at least one processor 806. The at least one transceiver 802 is coupled to the at least one processor 806.

Although in this figure, elements such as the transceiver 802 and the processor 806 are illustrated in the singular, the plural is contemplated unless a limitation to the singular is explicitly stated. In some embodiments of the present application, the transceiver 802 may be divided into two devices, such as receiving circuitry (or a receiver) and transmitting circuitry (or a transmitter). In some embodiments of the present application, the apparatus 800 may further include an input device, a memory, and/or other components. The transceiver 802 and the processor 806 may be configured to perform any of the methods described herein (e.g., the methods described with respect to FIGS. 2-7 or other methods described in the embodiments of the present application).

According to some embodiments of the present application, the apparatus 800 may be a target UE, and the transceiver 802 and the processor 806 may be configured to perform operations of the target UE in any of the methods as described with respect to FIGS. 2-7 or other methods described in the embodiments of the present application. For example, the processor 806 is configured to: receive a first request, via the transceiver 802, from an LMF of a wireless network, the first request indicating to the target UE for obtaining measurement information associated with a position of the target UE; responsive to the first request being received from the LMF, and in the case that a Uu positioning configuration and an SL positioning configuration of the target UE are not operationally aligned, obtain an updated positioning configuration for obtaining the measurement information associated with the position of the target UE; obtain the measurement information associated with the position of the target UE using the updated positioning configuration; and transmit the obtained measurement information, via the transceiver 802, to the LMF for determining the position of the target UE.

According to some embodiments of the present application, the apparatus 800 may be a BS, and the transceiver 802 and the processor 806 may be configured to perform operations of the BS in any of the methods as described with respect to FIGS. 2-7 or other methods described in the embodiments of the present application. For example, the processor 806 is configured to: obtain information related to an SL positioning for a first UE for which a transition from a standalone Uu or SL positioning to a hybrid Uu and SL positioning is initiated; determine at least one of a Uu PPW or an SL PPW based at least in part on the information related to the SL positioning for the first UE; and transmit, via the transceiver 802, information of the determined at least one of the Uu PPW or the SL PPW to at least one of the first UE or second UE(s) for performing SL positioning for the first UE.

According to some embodiments of the present application, the apparatus 800 may be an LMF, and the transceiver 802 and the processor 806 may be configured to perform operations of the LMF in any of the methods as described with respect to FIGS. 2-7 or other methods described in the embodiments of the present application. For example, the processor 806 is configured to: transmit a first request, via the transceiver 802, to a first UE, the first request indicating to the first UE for obtaining measurement information associated with a position of the first UE; responsive to the first request being transmitted from the LMF, and in the case that a Uu positioning configuration and an SL positioning configuration of the first UE are not operationally aligned, transmit an updated positioning configuration, via the transceiver 802, to the first UE for the first UE to obtain the measurement information associated with the position of the first UE; and receive, via the transceiver 802, the measurement information from the first UE for determining the position of the first UE.

In some embodiments of the present application, the apparatus 800 may further include at least one non-transitory computer-readable medium. In some embodiments of the present disclosure, the non-transitory computer-readable medium may have stored thereon computer-executable instructions to cause the processor 806 to implement any of the methods as described above. For example, the computer-executable instructions, when executed, may cause the processor 806 to interact with the transceiver 802, so as to perform operations of the methods, e.g., as described with respect to FIGS. 2-7 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for hybrid positioning, including a processor and a memory. Computer programmable instructions for implementing a method for hybrid positioning are stored in the memory, and the processor is configured to perform the computer programmable instructions to implement the method for hybrid positioning. The method for hybrid positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for hybrid positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A first user equipment (UE) for wireless communication, comprising:
at least one memory; and
at least one processor coupled with the at least one memory and operable to cause the first UE to:
receive a first request from a location management function (LMF) of a wireless network, the first request indicating to the first UE for obtaining measurement information associated with a position of the first UE;
obtain, responsive to the first request being received from the LMF and based at least in part on a Uu positioning configuration and a sidelink (SL) positioning configuration of the first UE not being operationally aligned, an updated positioning configuration for obtaining the measurement information associated with the position of the first UE;
obtain the measurement information associated with the position of the first UE using the updated positioning configuration; and
transmit the obtained measurement information to the LMF for determining the position of the first UE.

2. The first UE of claim 1, wherein the at least one processor is operable to cause the first UE to:
transmit Uu measurement information associated with the position of the first UE to the LMF, wherein the first request is received based at least in part on the Uu measurement information.

3. The first UE of claim 1, wherein the at least one processor is operable to cause the first UE to:
receive, one or more conditions from the LMF; and
transmit a first assistance data in response to the one or more conditions being satisfied, wherein the first request is received based at least in part on the first assistance data.

4. The first UE of claim 3, wherein the one or more conditions comprise:
a link quality of at least one Uu connection is lower than a first pre-defined threshold during a time window, while a link quality of at least one other Uu connection is higher than a second pre-defined threshold during the time window; and
at least one SL connection is able to be established and a link quality of the at least one SL connection is higher than a third pre-defined threshold during the time window.

5. The first UE of claim 1, wherein:
the first request includes at least one of:
information of at least one second UE for performing SL positioning for the first UE;
a second request indicating the first UE to discover at least one second UE for performing SL positioning for the first UE; or
an updated Uu positioning configuration; or the first request includes at least one of:
information of at least one base stations (BS) for performing Uu positioning for the first UE;
updated information of at least one second UE for performing SL positioning for the first UE; or
a third request indicating the first UE to reselect at least one second UE for performing SL positioning for the first UE.

6. The first UE of claim 1, wherein the at least one processor is operable to cause the first UE to receive information of a SL positioning reference signal (PRS) processing window (PPW) from a serving base station (BS) of the first UE or from the LMF, wherein the SL PPW aligns with a Uu PPW configured for the first UE.

7. The first UE of claim 1, wherein the at least one processor is operable to cause the first UE to:
transmit SL measurement information associated with the position of the first UE or a second assistance data to the LMF, wherein the first request is received based at least in part on the SL measurement information or the second assistance data, and wherein the second assistance data indicates at least one of:
a position estimation of the first UE computed based on SL measurement information associated with the position of the first UE failing to satisfy a quality of service (QOS) requirement of a positioning service; or
a failure of SL measurement.

8. The first UE of claim 3, wherein the one or more conditions comprise:
a link quality of at least one SL connection associated with at least one second UE being lower than a fourth pre-defined threshold during a time window and the first UE cannot find one or more second UEs to replace the at least one second UE for performing SL positioning for the first UE during the time window, while a link quality of one or more other SL connections is higher than a fifth pre-defined threshold during the time window, wherein a number of the one or more other SL connections is no more than a requested number; and
at least one Uu connection can be established and a link quality of the at least one Uu connection is higher than a sixth pre-defined threshold during the time window.

9. The first UE of claim 1, wherein the at least one processor is operable to cause the first UE to receive information of a Uu positioning reference signal (PRS) processing window (PPW) and one or more associated identities (IDs) from a serving base station (BS) of the first UE, wherein the Uu PPW aligns with a SL PPW.

10. A location management function (LMF) of a wireless network, comprising:
at least one memory; and
at least one processor coupled with the at least one memory and operable to cause the LMF to:
transmit a first request to a first user equipment (UE), the first request indicating to the first UE for obtaining measurement information associated with a position of the first UE;
transmit, responsive to the first request being transmitted from the LMF and based at least in part on a Uu positioning configuration and a sidelink (SL) positioning configuration of the first UE being not operationally aligned, an updated positioning configuration to the first UE for the first UE to obtain the measurement information associated with the position of the first UE; and
receive the measurement information from the first UE for determining the position of the first UE.

11. The LMF of claim 10, wherein the at least one processor is operable to cause the LMF to receive at least one of:
first Uu measurement information associated with the position of the first UE from the first UE; or
second Uu measurement information associated with the position of the first UE from at least one base station (BS) for performing Uu positioning for the first UE; and
the at least one processor is operable to cause the LMF to determine, before the first request is transmitted, to initiate a hybrid positioning procedure in response to at least one of:
a position estimation of the first UE computed based on the at least one of the first Uu measurement information or the second Uu measurement information failing to satisfy a quality of service (QOS) requirement of a positioning service; or
the at least one of the first Uu measurement information or the second Uu measurement information indicating a failure of Uu measurement.

12. The LMF of claim 10, wherein the at least one processor is operable to cause the LMF to receive, from the first UE, a response indicating at least one of:
a confirmation of the first request; or
one or more second UEs selected by the first UE for performing SL positioning for the first UE; or
wherein the at least one processor is operable to cause the LMF to receive, from the first UE, at least one of:
a confirmation of the first request; or
one or more second UEs reselected by the first UE for performing SL positioning for the first UE.

13. The LMF of claim 10, wherein the at least one processor is operable to cause the LMF to:
receive SL measurement information associated with the position of the first UE or a third assistance data from at least one of the first UE or at least one second UE for performing SL positioning for the first UE; and
determine, before the first request is transmitted, to initiate a hybrid positioning procedure in response to at least one of:
a position estimation of the first UE computed based on the received SL measurement information failing to satisfy a quality of service (QOS) requirement of a positioning service;
the received SL measurement information indicating a failure of SL measurement; or
the third assistance data indicating at least one of:
a position estimation of the first UE computed based on SL measurement information associated with the position of the first UE failing to satisfy a QoS requirement of a positioning service; or
a failure of SL measurement.

14. The LMF of claim 10, wherein the at least one processor is operable to cause the LMF to transmit, to a serving base station (BS) of the first UE, at least one of:
information of a SL positioning reference signal (PRS) processing window (PPW); or
updated information of at least one second UE for performing SL positioning for the first UE.

15. A base station (BS for wireless communication, comprising:
at least one memory; and
at least one processor coupled with the at least one memory and operable to cause the BS to:
obtain information related to a sidelink (SL) positioning for a first user equipment (UE) for which a transition from a standalone Uu or SL positioning to a hybrid Uu and SL positioning is initiated;
determine at least one of a Uu positioning reference signal (PRS) processing window (PPW) or an SL PPW based at least in part on the information related to the SL positioning for the first UE; and
transmit information of the determined at least one of the Uu PPW or the SL PPW to at least one of the first UE or at least one second UE for performing SL positioning for the first UE.

16. A method performed by a first user equipment (UE), the method comprising:
receiving a first request from a location management function (LMF) of a wireless network, the first request indicating to the first UE for obtaining measurement information associated with a position of the first UE;
obtaining, responsive to the first request being received from the LMF and based at least in part on a Uu positioning configuration and a sidelink (SL) positioning configuration of the first UE not being operationally aligned, an updated positioning configuration for obtaining the measurement information associated with the position of the first UE;
obtaining the measurement information associated with the position of the first UE using the updated positioning configuration; and
transmitting the obtained measurement information to the LMF for determining the position of the first UE.

17. The method of claim 16, further comprising:
transmitting Uu measurement information associated with the position of the first UE to the LMF, wherein the first request is received based at least in part on the Uu measurement information.

18. The method of claim 16, further comprising:
receiving one or more conditions from the LMF; and
transmitting a first assistance data in response to the one or more conditions being satisfied, wherein the first request is received based at least in part on the first assistance data.

19. The method of claim 18, wherein the one or more conditions comprise:
a link quality of at least one Uu connection is lower than a first pre-defined threshold during a time window, while a link quality of at least one other Uu connection is higher than a second pre-defined threshold during the time window; and
at least one SL connection is able to be established and a link quality of the at least one SL connection is higher than a third pre-defined threshold during the time window.

20. The method of claim 16, wherein:
the first request includes at least one of:
information of at least one second UE for performing SL positioning for the first UE;
a second request indicating the first UE to discover at least one second UE for performing SL positioning for the first UE; or
an updated Uu positioning configuration; or the first request includes at least one of:
information of at least one base stations (BS) for performing Uu positioning for the first UE;
updated information of at least one second UE for performing SL positioning for the first UE; or
a third request indicating the first UE to reselect at least one second UE for performing SL positioning for the first UE.
